(19) United States
(12) Patent Application Publication
(10) Pub. No.: US 2003/0020259 A1
(43) Pub. Date: Jan. 30, 2003

(54) Collapsible dual-seat jogging stroller with side rails

(76) Inventors: Chuan-Tso Tai, Chi-I Hsien (TW); Cheng-Wel Lu, Chi-I Hsien (TW)

Correspondence Address: HARNESS,DICKEY & PIERCE, P.L.C., P.O. BOX 8910, RESTON, VA, 20195, US

(21) Appl. No.: 09/915,341

(22) Filed: Jul. 27, 2001

(51) Int. Cl. B62B 7/06

(52) U.S. Cl. 280/647; 280/639

(57) ABSTRACT

A jogging stroller has a collapsible frame comprising two side rails having rear ends pivotably coupled to handle, two front wheel sub-frames having rear ends pivotably coupled to front ends of side rails and front ends rotatably coupled to a front wheel, two rear wheel sub-frames having front ends pivotably coupled to front ends of side rails and rear ends rotatably coupled to rear wheels, two base rails having front ends pivotably coupled to front wheel sub-frames and rear ends pivotably coupled to handle, and a seat assembly extended upwardly from base rails and including a front seat and a rear seat in a longitudinally aligned relationship to the front seat. In collapsing, front wheel sub-frames and rear wheel sub-frames are pivoted toward side rails, handle is pivoted toward side rails, and base rails are moved to abut on side rails as the pivoting of front wheel sub-frames and handle, resulting in a reduction of storage space.

### BACKGROUND OF THE INVENTION

1. Field of Invention

The present invention relates to jogging strollers and more particularly to an improved collapsible dual-seat jogging stroller with side rails as a safety means.

2. Related Art

A conventional stroller is equipped with smaller wheels for the sake of, for example reduced storage space after collapsed. Hence, such stroller is designed to move along a generally planar ground. In the case of moving on a rough road, the person pushing stroller has to slow down. Otherwise, stroller may be damaged and causes an uncomfortableness to or even hurt the occupant due to strong vibration.

As health consciousness arises, parents especially young ones like to jog while pushing stroller. If parents push a conventional stroller rather than jogging stroller to walk around, they have to choose relatively smooth roads instead of rough roads. This may frustrate the parents if the rough roads are desired. Also, large wheeled jogging strollers are attractive to some people even they are relatively large in size. The diameter of wheel of a typical jogging stroller is of about 15 inches. Hence, it is not an easy design to fold frame and wheels of a jogging stroller into a bundle of sufficient compactness. Further, dual-seat jogging strollers are popular among many parents having two children because the parents would like to carry two children for a stroll without having to leave one of them at home.

Dual-seat jogging strollers are well known. For example, U.S. Pat. No. 5,263,730 to Roach discloses a jogging stroller having an elongate planar platform mounted in a base frame rail, two seats in a longitudinally aligned relationship to the underlying platform, and three detachable wheels including a front wheel and two rear wheels for saving storage space after collapsed. Roach's patent is advantageous for being rigid in structure while is disadvantageous for being not collapsible. Further, U.S. Design Pat. No. D418,780 to Everett discloses a dual-seat jogging stroller which is advantageous for wheels being detachable easily while is disadvantageous for the increase of width for accommodating two transversely aligned seats and a prolonged rear axle which in turn may increase the difficulty in collapsing the jogging stroller. Further, no side rail provided as a safety means. In the case that one child stands up a danger may occur (e.g., fall) since no safety means provision.

Above increase of width and a prolonged rear axle are not desirable. Moreover, collapsible dual-seat jogging stroller is not disclosed as far as the present inventor knows despite of many collapsible single-seat jogging stroller on the market. Thus, it is desirable to provide a new and improved collapsible dual-seat jogging stroller having safety means in order to overcome the above drawbacks of prior art.

### SUMMARY OF THE INVENTION

It is therefore an object of the present invention to provide a collapsible dual-seat jogging stroller with side rails as a safety means.

The advantages of the present invention are realized by providing a jogging stroller including a front wheel, two rear wheels, and a collapsible frame comprising a rear handle; two side rails having rear ends pivotably coupled to the handle; two front wheel sub-frames having rear ends pivotably coupled to front ends of the side rails and front ends rotatably coupled to the front wheel; two rear wheel sub-frames having front ends pivotably coupled to front ends of the side rails and rear ends rotatably coupled to the rear wheels; two base rails having front ends pivotably coupled to the front wheel sub-frames and rear ends pivotably coupled to the handle; and a seat assembly extended upwardly from the base rails and including a front seat and a rear seat in a longitudinally aligned relationship to the front seat. In collapsing the jogging stroller, front wheel sub-frames are pivoted toward side rails, handle is pivoted toward side rails, and base rails are moved to abut on side rails as the pivoting of front wheel sub-frames and handle. As a result, the space of collapsed jogging stroller is reduced to a minimum.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become fully understood from the detailed description given hereinbelow illustration only, and thus are not limitative of the present invention, and wherein:

FIG. 1 is a perspective view of a collapsible dual-seat jogging stroller according to the invention;

FIG. 2 is a side view of the FIG. 1 jogging stroller; and

FIG. 3 is a view similar to FIG. 1 where only frame and wheels are shown.

### DETAILED DESCRIPTION OF THE INVENTION

It is noted that the connection of front wheel sub-frames and front wheel (or rear wheel sub-frames and rear wheels) is well known. For example, it is disclosed in U.S. Pat. Nos. 4,953,800, 5,562,300, and 5,536,033. Further, the disassembly of wheels and frame is well known. Thus a detailed description thereof is omitted herein for the sake of brevity.

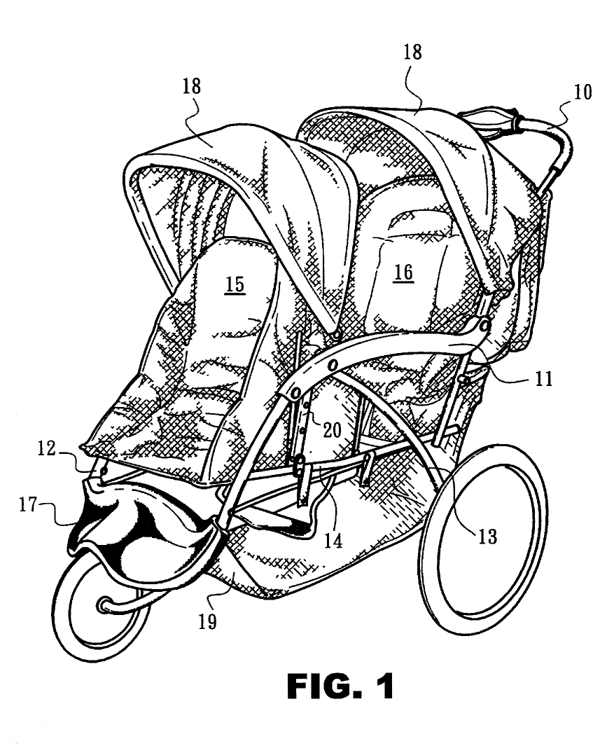

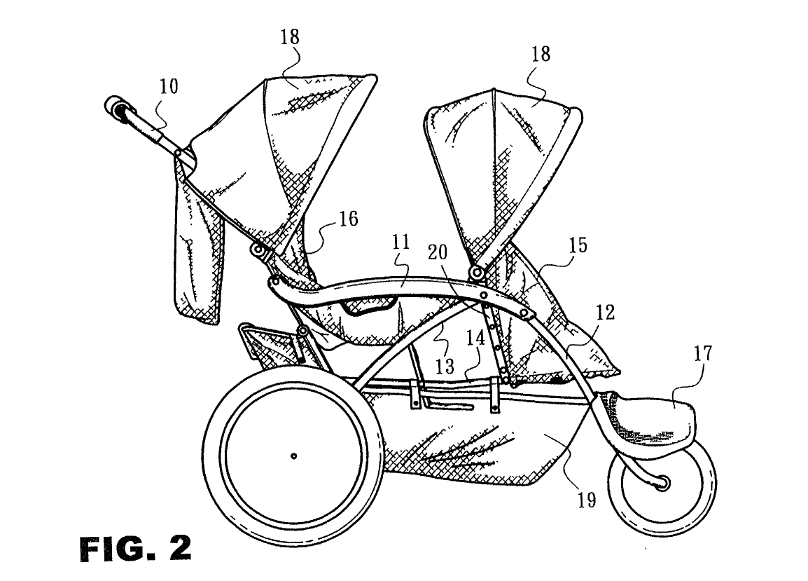

Referring to FIGS. 1 and 2, there is shown a collapsible dual-seat jogging stroller constructed in accordance with the invention comprising a front seat 15, a rear seat 16 in a longitudinally aligned relationship to the front seat 15, a collapsible sunshade 18 above either seat, a side rail 11 on either side of seat, a footrest 17 (also served as mud flap) below front seat 15, and a handle 10 as a pushing means.

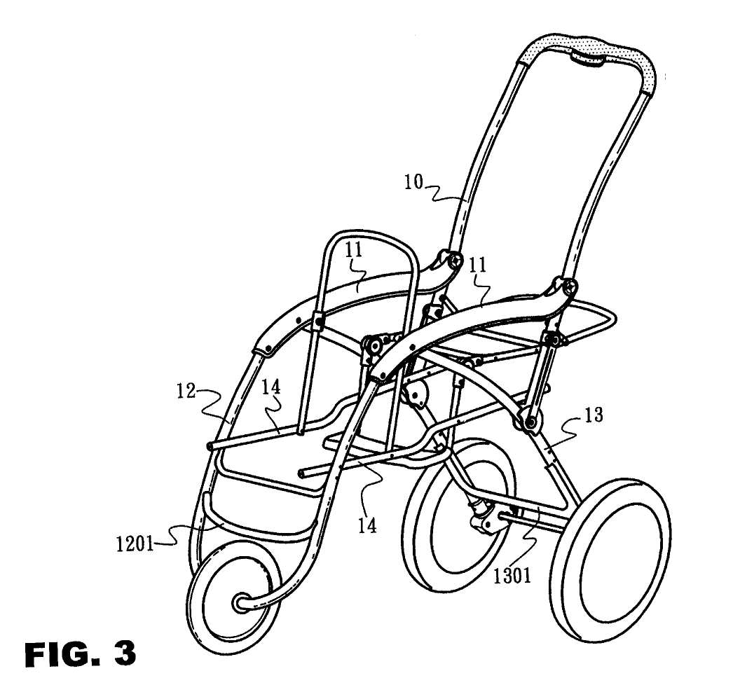

Referring to FIG. 3, the frame of jogging stroller comprises a U-shaped handle 10, two side rails 11, two front wheel sub-frames 12, and two rear wheel sub-frames 13 wherein handle 10 is pivotably coupled to side rails 11 on two ends. Note that the shape of handle 10 may be other than above U as appreciated by those skilled in the art. For example, U.S. Pat. No. 5,562,300 discloses a jogging stroller having two independent left and right handles coupled together by a cross bar. Also, U.S. Pat. No. 5,882,030 discloses an infant stroller having two independent upward bent left and right handles. Such variations are intended to be included within the scope of the invention. Since side rails 11, on both sides of front seat 15 and rear seat 16, are pivotably coupled to handle 10 it is possible of folding handle 10 toward side rails 11 for reducing storage space in an unused state.

Front wheel sub-frame 12 has one rear end pivotably coupled to side rail 11. Hence, it is possible of folding front wheel sub-frames 12 toward side rails 11 to stack with handle 10. A cross bar 1201 is coupled between front wheel sub-frames 12. Front ends of front wheel sub-frames 12 are rotatably coupled to front wheel. Front wheel sub-frames 12 may be formed as U, V, or any of other shapes. The only consideration is to arrange the pivot positions of rear ends of front wheel sub-frames 12 and side rails 11 to be as near the front wheel as possible, whereby it is possible of supporting side rails 11 in conjunction with handle 10 and decreasing the total length of collapsed jogging stroller.

Rear wheel sub-frames 13 are coupled together by a cross bar 1301. Front ends of rear wheel sub-frames 13 are coupled to side rails 11, while rear ends thereof are rotatably coupled to rear wheels. Note that in other embodiments the number of cross bar 1301 may be more than one in consideration the strength of frame. The only consideration is to arrange the pivot positions of front ends of rear wheel sub-frames 13 and side rails 11 to be as near the front wheel as possible, whereby side rails 11 and rear wheel sub-frames 13 may be stacked closely and it is possible of reducing the total storage space of collapsed jogging stroller.

A base rail 14 is coupled to either side of front seat 15 and rear seat 16. Front end of base rail 14 is pivotably coupled to front wheel sub-frame 12 and rear end thereof is pivotably coupled to lower end of handle 10. In collapsing jogging stroller, front wheel sub-frames 12 are pivoted toward side rails 11, handle 10 is pivoted toward side rails 11, and base rails 14 are moved to abut on side rails 11 as the pivoting of front wheel sub-frames 12 and handle 10. As a result, the space of collapsed jogging stroller is reduced to a minimum.

In a preferred embodiment, a basket 19 is provided under base rails 14 for storing feeding bottles, toys, clothes or the like.

The invention being thus described, it will be obvious that the same may be varied in many ways. For example, the connection of front wheel sub-frames 12 and front wheel and/or rear wheel sub-frames 13 and rear wheels may be different from described above. Also, many prior art have disclosed the connection such as U.S. Pat. Nos. 4,953,800, 5,562,300, and 5,536,033. The only requirement is how to easily detach front and rear wheels from frame without using tools. In this regard, such variations are not to be regarded as a departure from the spirit and scope of the invention, and all such modifications as would be obvious to one skilled in the art are intended to be included within the scope of the following claims.

What is claimed is:

1. A jogging stroller including a front wheel, two rear wheels, and a collapsible frame comprising:
a rear handle as means for pushing;
two side rails having rear ends pivotably coupled to said handle;
two front wheel sub-frames having rear ends pivotably coupled to front ends of said side rails and front ends rotatably coupled to said front wheel;
two rear wheel sub-frames having front ends pivotably coupled to front ends of said side rails and rear ends rotatably coupled to said rear wheels;
two base rails having front ends pivotably coupled to said front wheel sub-frames and rear ends pivotably coupled to said handle; and
a seat assembly extended upwardly from said base rails and including a front seat and a rear seat in a longitudinally aligned relationship to said front seat.

2. The jogging stroller of claim 1, wherein pivot positions of said rear wheel sub-frames and said side rails are proximate that of said front wheel sub-frames and said side rails so that said rear and said front wheel sub-frames are stacked after collapsed.

3. The jogging stroller of claim 1, further comprising a collapsible sunshade above said seat assembly.

4. The jogging stroller of claim 1, wherein said front wheel sub-frames are detachably coupled to said front wheel.

5. The jogging stroller of claim 1, further comprising a footrest served as a mud flap above said front wheel.

6. The jogging stroller of claim 1, further comprising a basket extended downwardly from said base rails.

7. A jogging stroller including a front wheel, two rear wheels, and a collapsible frame comprising:
a rear handle as means for pushing;
two side rails having rear ends pivotably coupled to said handle;
two front wheel sub-frames together being substantially a U or V, disposed in a front side of said stroller, and having rear ends pivotably coupled to front ends of said side rails and front ends rotatably coupled to said front wheel;
two oblique rear wheel sub-frames having front ends pivotably coupled to front ends of said side rails and rear ends rotatably coupled to said rear wheels;
two base rails having front ends pivotably coupled to said front wheel sub-frames and rear ends pivotably coupled to said handle; and
a seat assembly extended upwardly from said base rails and including a front seat and a rear seat in a longitudinally aligned relationship to said front seat.

8. The jogging stroller of claim 7, wherein pivot positions of said rear wheel sub-frames and said side rails are proximate that of said front wheel sub-frames and said side rails so that said rear and said front wheel sub-frames are stacked after collapsed.

9. The jogging stroller of claim 7, wherein said handle is of substantially U-shaped.

10. The jogging stroller of claim 7, further comprising a collapsible sunshade above said seat assembly.

11. The jogging stroller of claim 7, further comprising a footrest served as a mud flap above said front wheel.

12. The jogging stroller of claim 7, further comprising a basket extended downwardly from said base rails.

13. The jogging stroller of claim 7, wherein said front wheel sub-frames are detachably coupled to said front wheel.

14. The jogging stroller of claim 7, wherein said rear wheel sub-frames are detachably coupled to said rear wheels.
